(19) United States
(12) Patent Application Publication
(10) Pub. No.: US 2005/0200605 A1
(43) Pub. Date: Sep. 15, 2005

(54) Input device with charging structure

(76) Inventor: Pen-Jen Chen, Taipei (TW)

Correspondence Address: BIRCH STEWART KOLASCH & BIRCH, PO BOX 747, FALLS CHURCH, VA, 22040-0747, US

(21) Appl. No.: 11/074,673

(22) Filed: Mar. 9, 2005

(30) Foreign Application Priority Data
Mar. 10, 2004 (TW) 093106297

(51) Int. Cl. G09G 5/08

(52) U.S. Cl. 345/163

(57) ABSTRACT

A computer peripheral input device with a charging member is proposed. The input device with charging structure includes an input member receiving at least one rechargeable battery and a pair of power input terminals thereon. A power processing member is used to receive power and process the power to power capable of being used by the rechargeable battery in, the input member, and a charging member having a pair of power transmitting teals for receiving processed powder from the power processing member. The input member is supplied with power via the rechargeable battery to control operations of an electrical device. A housing of the charging member is extended for engaging with a housing of the input member, and the charging member is assembled to the input member in a horizontal orientation for enabling the power input terminals of the input member to respectively contact with power transmitting terminals of the charging member so that the power input terminals of the input member receive processed power from the power transmitting terminals of the charging member to function as a power supply for the rechargeable battery in the input member, thereby enabling the input member to be used while being charged at the same time.

### BACKGROUND OF THE INVENTION

1. Field of the Invention

The invention relates to a computer peripheral input device, and more particularly, to an input device capable of being used while being: charged at the same time.

2. Description of the Related Art

Presently, wireless mice that must be periodically recharged using a wired charging station are widely used. As shown in FIG. 1, a rechargeable battery (not shown) in a wireless mouse 10 is charged by a charging station 11. The charging station 11 has a processing circuit which controls voltage induction, voltage conversion, voltage charging or voltage discharging (not shown). The processing circuit is able to process power from a power line 13 to power capable of being used by the rechargeable battery in the wireless mouse 10 for charging.

The charging station 11 has a receiving space 16 for receiving the wireless mouse 10. A pair of metal contact pins 12 projects from the receiving space 16. The metal contact pins 12 can transmit power processed by the processing circuit to a pair of metal contact plates 14 of the wireless mouse 10 while received in the receiving space 16 for enabling processed power to be transmitted to the rechargeable battery of the wireless mouse 10 for charging.

However, according to the above means, since the wireless mouse 10 is stacked (or “piggybacked”) on top of the charging station 11 to accomplish charging (see FIG. 2), the wireless mouse 10 cannot be used during charging, which limits the usage of the wireless mouse 10. Moreover, since the wireless mouse 10 and the charging station 1 are piggybacked, the metal contact plates 14 on the backside 15 of the wireless mouse 10 cannot be easily aligned with the metal contact pins 12 on the charging station 11, thereby hindering the charging process.

### SUMMARY OF THE INVENTION

In light of the drawbacks above, the primary objective of the present invention is to provide an input device with a charging structure capable of being used while charging.

Another objective of the present invention is to provide an input device with a charging structure which can, through use of concave and protruding structures engaging with each other in the vicinity of contact plates of an input member and contact pins of a charging member to enhance the engagement of the input member and the charging member.

In accordance with the above and other objectives, the present invention proposes an input device with a charging structure. The input device includes: an input is member and a charging member. The input member receives at least one rechargeable battery therein and bas a plurality of power input terminals disposed on a housing of the input member, the input member is supplied with power via the rechargeable battery to control operations of an electronic device. The charging member has a plurality of power transmitting terminals on a housing thereof, wherein the housing of the charging member is extended for engaging with the housing of the input member. The charging member receives power and processes the power to power capable of being used to charge the rechargeable battery of the input member by being assembled to the input member in a horizontal orientation, enabling the power input terminals of the input member to respectively contact with the power transmitting terminals of the charging member. Hence, the power input terminals of the input member receive processed power from the power transmitting terminals of the charging member to supply power to the rechargeable battery in the input member, thereby enabling the input member to be used while being charged at the same time.

Furthermore, concave and protruding portions that can be mutually engaged are respectively formed in vicinities of power input terminals on the input member and power transmitting terminals on the charging member to enhance the engagement between the input member and the charging member.

To provide a further understanding of the invention, the following detailed description illustrates embodiments and examples of the invention, it should be understood that this detained description is being provided only for illustration of the invention and not as limiting the scope of this invention.

### BRIEF DESCRIPTION OF THE DRAWINGS

The drawings included herein provide a further understanding of the present invention.

FIG. 1 (PRIOR ART) is a configuration schematic view of a conventional wireless mouse and a conventional charging station;

FIG. 2 (PRIOR ART) is an assembled view of the conventional wireless mouse and the conventional charging station of FIG. 1;

FIG. 3 is a configuration schematic view of an input device with a charging structure in accordance with the present invention;

FIG. 4 is a top view of the input device with the charging structure of FIG. 3 mated together; and

FIG. 5 is a schematic view of using the input device with the charging structure in accordance with the present invention.

### DETAILED DESCRIPTION OF THE PREFERRED EMBODIMENTS

Reference will now be made in detail to the preferred embodiment of the present invention, the advantages and functions of the present invention will be readily discernible to those skilled in the art after reading the detailed description. The present invention should therefore cover various modifications and variations made to the herein-described structure and operations of the present invention, provided they fall within the scope of the invention.

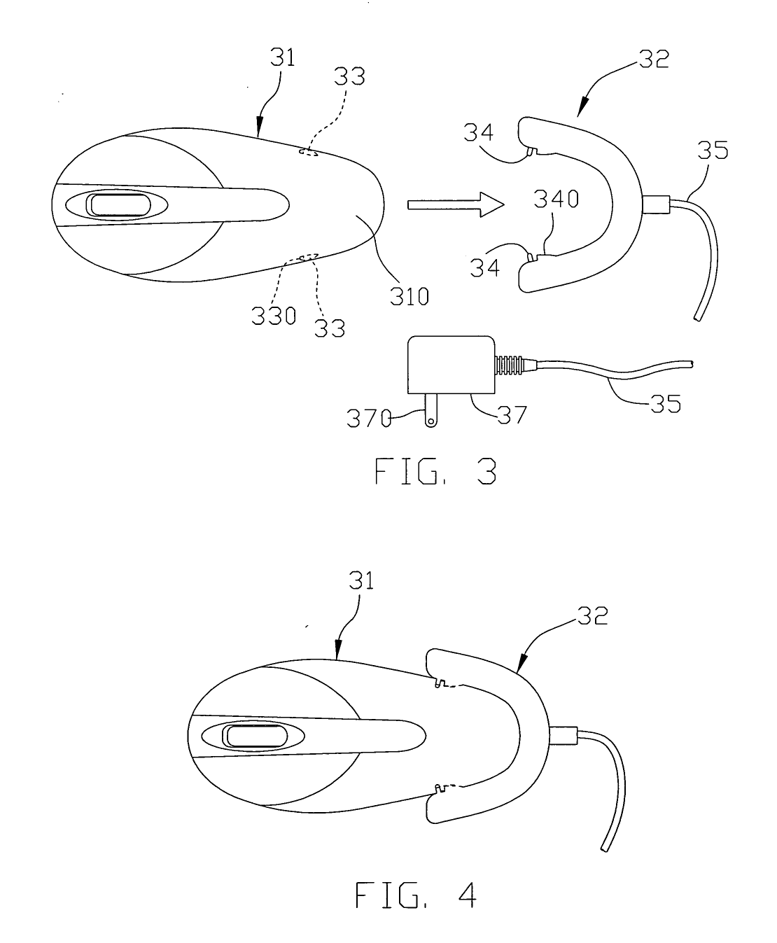

Referring to FIG. 3, a configuration schematic view is shown of an input device with a charging structure in accordance with the present invention. The input device with the charging structure of the present invention includes an input member 31 such as a mouse, a charging member 32, and a power processing member 37 such as an AC power adapter with a transformer. It is noted here that the input member 31, the charging member 32, and the power processing member 37 would include other components, but for simplifying the drawings and illustrations, only components relevant to the present invention are illustrated. Other irrelevant components such as a charging-status indicator or a motion-sensing member of the wireless mouse are not illustrated in the drawings of the present invention.

The input member 31 has a rechargeable battery (not shown) therein for supplying power to its internal electrical circuitry. A user is able to control operations of an electrical device (not shown) such as a desktop or a notebook PC by operating the input member 31. The input member 31 has a handclasp portion 310 and a pair of power input terminals 33 (e.g. a pair of metal contact plates) exposed on an outer edge of the handclasp portion 310.

The power processing member 37 can obtain power (electrical supply) from a receptacle (not shown) via a pair of power plugs 370. The power processing member 37 has a processing circuit that controls voltage conversion and voltage regulation (not shown, because these functions are the conventional functions of a common charging device, and hereafter, the functions and structures of the processing circuit will not be detailed). The processing unit processes the power received via the power plugs 370 to power capable of being used by the rechargeable battery in the input member 31.

The charging member 32 is connected with the power processing member 37 via a power line 35. The housing of the charging member 32 is shaped such that it matches with the housing of the input member 31. A pair of power transmitting terminals 34 is used for receiving processed power from the power processing member 37 and supplying the received power to the rechargeable battery of the input member 31. The pair of terminals 34, for example, a pair of metal contact pins is defined on an inner side of the charging member 32.

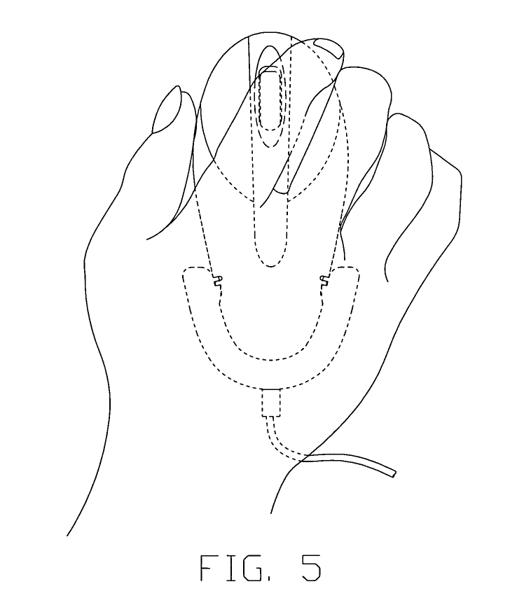

In the present embodiment, since the housing of the charging member 32 is extended to match with the housing of the input member 31, the charging member 32 forms a U-shaped structure for matching with the input member 31 in a elliptical shape, such that the charging member 32 can be firmly assembled to the input member 31 in a horizontal orientation. During assembly, the power input terminals 33 of the input member 31 contact with the power transmitting terminals 34 of the charging member 32 for enabling the power transmitting terminals 34 to transmit processed power to the power input terminals 33 of the input member 31 to charge the rechargeable battery in the input member 31. Because the charging member 32 is assembled to the rear of the handclasp portion 310 which a user's hand can clasp, the input member 31 is capable of being used by the user during charging (see FIG. 5).

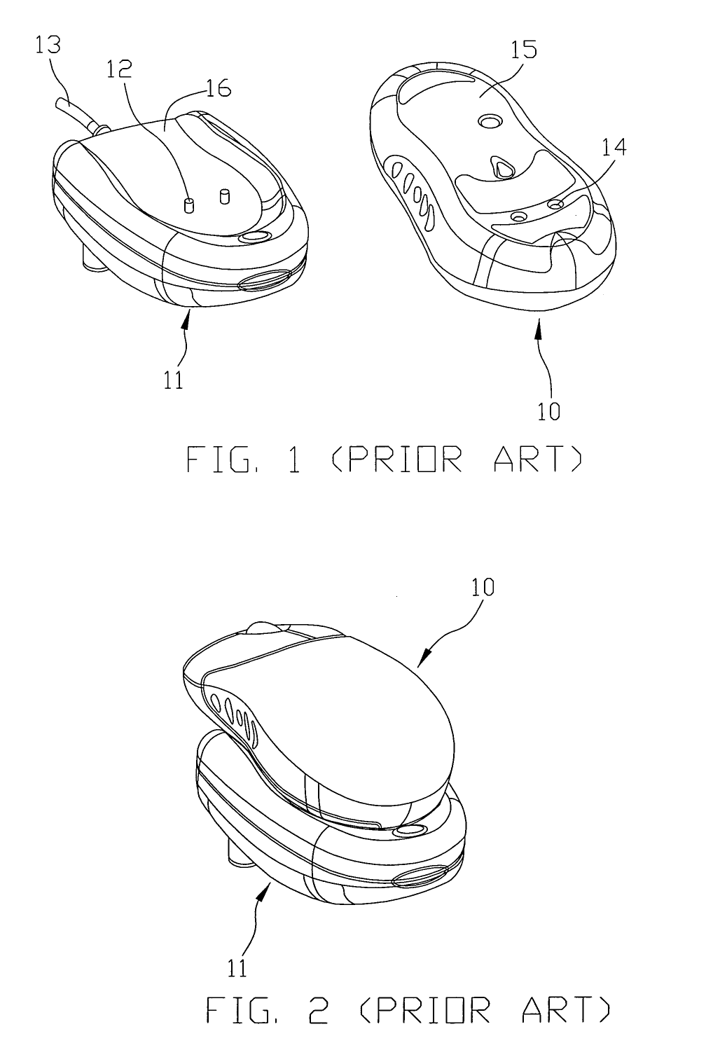

In addition, in the present embodiment the power input terminals 33 of the input member 31 are respectively disposed in a pair of concave portions 330, and the charging member 32 defines a pair of protruding portions 340 near the power transmitting terminals 34 (see FIG. 1). When the charging member 32 is assembled to the input member 31 horizontally so that each power input terminal 33 of the input member 31 is in contact with each power transmitting terminal 34 of the charging member 32, each protruding portion 340 of charging member 32 is received in respective concave portion 330 of the input member 31 so that the input member 31 can be even more firmly assembled to the charging member 32. As a result, each power input terminal 33 of the input member 31 could be precisely aligned to and in contact with each power transmitting terminal 34 of the charging member 32.

Accordingly, the input device with a charging structure of the present invention is characterized in that the input member 31 is assembled to the charging member 32 in a horizontal orientation for charging the rechargeable battery in the input member 31 so that the input member 31 is capable of being used by the user during charging. Furthermore, the input member 31 forms the concave portions 33Q near the power input terminals 33 while the charging member 32 forms the protruding portions 340 near the power transmitting terminals 34, whereby the engagement of the concave portions 330 and the protruding portions 340 allows the power input terminals 33 to precisely contact the power transmitting terminals 34. Hence, the problem that the user cannot use a conventional wireless mouse 10 during charging because the conventional wireless mouse 10 is disposed in a receiving space 16 of a charging station 11 as described in the prior art can be solved.

It is noted that, alternatively, the processing circuit can be provided in the charging member 32 instead of the power processing member 37, and a power line with a power plug (not shown) can be extended from the charging member 32 for enabling the power plug of the charging member 32 to be inserted into a power receptacle (not shown) providing power (electrical supply). In this embodiment, the charging member 32 processes power from the power plug to power capable of being used by the rechargeable battery in the input member 31 by the processing circuit.

It is to be understood that this detailed description is being provided only for illustration of the invention and not limiting the scope of this invention. For example, the charging member 32 not only can be assembled to the rearm of the handclasp portion 310, but also assembled to any side of the housing of the input member 32 as long as the power transmitting terminals 34 of the charging member 32 correspond to the position of the power input terminals 33. Moreover, the housing of the charging member 32 may not only be a U-shaped structure, but also other structures such as a C-shaped or chevron-shaped structures for mating with the housing of the input member 31 as long as the charging member 32 can be firmly mated to the input member 31 horizontally. The invention should therefore cover various modifications and variations made to the herein-described structures and operations of the invention, provided they fall within the scope of the invention as defined in the following appended claims.

1. An input device with a charging structure comprising:
an input member receiving at least one rechargeable battery therein and having a plurality of power input terminals disposed on a housing of the input member, the input member being supplied with power via the rechargeable battery to control operations of an electronic device;
a power processing member for receiving power and processing the power to power capable of being used for charging the rechargeable battery in the input member; and
a charging member connecting with the power processing member, wherein a housing of the charging member is extended for engaging with the housing of the input member, a plurality of power transmitting terminals for receiving processed power from the power processing member are provided on the housing of the charging member, the charging member is assembled to the input member in a horizontal orientation for enabling each power input terminal of the input member to respectively contact with each power transmitting terminal of the charging member, such that the power input terminals of the input member receive processed power from the power transmitting terminals of the charging member to supply power to the rechargeable battery in the input member, thereby enabling the input member to be used while being charged simultaneously.

2. The input device with a charging structure of claim 1, wherein the power processing member is electrically connected with the charging member by a power line.

3. The input device with a charging structure of claim 1, wherein the input member is a wireless mouse.

4. The input device with a charging structure of claim 1, wherein the plurality of power input terminals is disposed at the rear of a handclasp portion of the input member.

5. The input device with charging structure of claim 1, wherein the shape of the housing of the charging member may be one of a U shape, a C shape and a chevron shape.

6. The input device with charging structure of claim 1, wherein portions that can be mutually engaged are respectively formed in the vicinities of power input terminals on the input member and power transmitting terminals on the charging member to enhance the engagement between the input member and the charging member.

7. An input device with a charging structure for use with an electronic device comprising:
an input member receiving at least one rechargeable battery therein and having a plurality of power input terminals disposed on a housing of the input member, the input member being supplied with power via the rechargeable battery to control operations of an electronic device; and
a charging member having a plurality of power transmitting terminals on a housing thereof wherein the housing of the charging member is extended for engaging with the housing of the input member, the charging member receives power and processes the power to power capable of being used to charge the rechargeable battery of the input member, the charging member is assembled to the input member in a horizontal orientation, enabling the power input terminals of the input member to respectively contact with the power transmitting terminals of the charging member so that the power input terminals of the input member receive processed power from the power transmitting terminals of the charging member to supply power to the rechargeable battery in the input member, thereby enabling the input member to be used while being charged simultaneously.

8. The input device with a charging structure of claim 7, wherein the input member is a wireless mouse.

9. The input device with a charging structure of claim 7, wherein the plurality of power input terminal is disposed at the rear of a handclasp portion of the input member.

10. The input device with a charging structure of claim 7, wherein the shape of the housing of the charging member may be one of a U shape, a C shape and a chevron shape.

11. The input device with charging structure of claim 7, wherein portions that can be mutually engaged are respectively formed in the vicinities of power input terminals on the input member and power transmitting terminals on the charging member to enhance the engagement between the input member and the charging member.
